(19) United States
(12) Patent Application Publication
(10) Pub. No.: US 2026/0002640 A1
(43) Pub. Date: Jan. 1, 2026

(54) MOBILE PRESSURE VESSEL

(71) Applicant: The Modern Group, Ltd., Beaumont, TX (US)

(72) Inventor: Gary MARKHAM, Beaumont, TX (US)

(21) Appl. No.: 19/229,895

(22) Filed: Jun. 5, 2025

Related U.S. Application Data
(60) Provisional application No. 63/665,084, filed on Jun. 27, 2024.

(51) Int. Cl. F17C 5/00

(52) U.S. Cl. CPC F17C 5/002; F17C 2201/0109; F17C 2201/035; F17C 2205/0157; F17C 2205/0326; F17C 2205/0332; F17C 2205/0352; F17C 2227/0135; F17C 2250/0417; F17C 2250/043; F17C 2250/0636; F17C 2260/04; F17C 2270/0171

(57) ABSTRACT

A method includes supplying a mobile pressure tank. The mobile pressure tank includes a pressure tank, with a trailer. The mobile pressure tank also includes an integrated spill containment system, the integrated spill containment system affixed to either the trailer or the pressure vessel and a maximum pressure safety valve positioned on the top portion, the maximum pressure safety valve having a maximum pressure. Further the mobile pressure tank includes a nitrogen blanket system, the nitrogen blanket system having a nitrogen pressure set point. The method also includes determining a fluid to be pumped into the pressure vessel, the fluid having a fluid vapor pressure and setting the nitrogen pressure set point above the fluid vapor pressure. The method further includes pumping the fluid into the pressure tank and relieving pressure in the pressure tank by allowing nitrogen to vent through the back pressure valve.

### CROSS-REFERENCE TO RELATED APPLICATIONS

This application is a nonprovisional application which claims priority from U.S. provisional application No. 63/665,084, filed Jun. 27, 2024, which is incorporated by reference herein in its entirety.

### TECHNICAL FIELD/FIELD OF THE DISCLOSURE

The present disclosure relates generally to a mobile pressure vessel.

### BACKGROUND OF THE DISCLOSURE

Rural areas without certain infrastructure may need tankage for storage of hazardous chemicals with significant vapor pressure, the discharge of which may be controlled by state and federal regulatory agencies. One traditional example is in chemical tank cleaning, such as in the chemical or petroleum industry, where the tank being cleaned may only be rated for 1 psi or less over atmospheric pressure and traditionally is vented to prevent pressure build up. When vapors must be vented, typically, a method of capturing or treating these vapors is often required. One traditional method of vapor treatment is using a bubbler to neutralize the vapors and then processing through a carbon treatment tank. These vapor remediation systems are typically tested and monitored.

### SUMMARY

The present disclosure provides for a method of operating a mobile pressure tank. The method includes supplying a mobile pressure tank. The mobile pressure tank includes a pressure tank, the pressure tank having a top portion, and a trailer, the pressure tank affixed to the trailer. The mobile pressure tank also includes an integrated spill containment system, the integrated spill containment system affixed to either the trailer or the pressure vessel and a maximum pressure safety valve positioned on the top portion, the maximum pressure safety valve having a maximum pressure. Further the mobile pressure tank includes a nitrogen blanket system, the nitrogen blanket system having a nitrogen pressure set point. The method also includes determining a fluid to be pumped into pressure vessel, the fluid having a fluid vapor pressure and setting the nitrogen pressure set point above the fluid vapor pressure. The method further includes pumping the fluid into the pressure tank and relieving pressure in the pressure tank by allowing nitrogen to vent through the back pressure valve.

The disclosure also includes a method of operating a mobile pressure tank. The method includes supplying a mobile pressure tank having a pressure tank, the pressure tank having a top portion and a trailer, the pressure tank affixed to the trailer. In addition, the mobile pressure tank includes an integrated spill containment system, the integrated spill containment system affixed to either the trailer or the pressure vessel and a maximum pressure safety valve positioned on the top portion, the maximum pressure safety valve having a maximum pressure. Further, the mobile pressure tank includes a primary fill valve, or a process valve, the primary fill valve, the process valve or the process valve having a motorized valve actuator and electronic controls. The electronic controls include a liquid level gauge in electrical connection with the pressure tank or the motorized fill valve and a pressure actuator and pressure sensor control, the pressure actuator and pressure sensor control in electrical connection with the motorized fill valve. The method includes pumping the fluid into the pressure tank through the primary fill valve or the process valve and controlling the primary fill valve or the process valve with the pressure actuator and pressure sensor control or the liquid level gauge in combination with the pressure actuator and pressure sensor control to keep a pressure tank pressure below the maximum pressure.

In addition, the disclosure includes a method of operating a mobile pressure tank. The method includes supplying a mobile pressure tank, the mobile pressure tank including a pressure tank with the pressure tank having a top portion and a backpressure valve on the top portion. Further, the mobile pressure tank includes a trailer, the pressure tank affixed to the trailer and a maximum pressure safety valve positioned on the top portion, the maximum pressure safety valve having a maximum pressure. The method also includes determining a fluid to be pumped into pressure vessel, the fluid having a fluid vapor pressure and setting a fixed back pressure. In addition, the method includes pumping the fluid into the pressure tank and relieving pressure in the pressure tank by allowing vapors in the tank to exit to a treatment system.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1A depicts a side view of a mobile pressure tank in a transportation position consistent with at least one embodiment of the present disclosure.

FIG. 1B depicts a side view of a mobile pressure tank in an operational position consistent with at least one embodiment of the present disclosure.

FIG. 2 depicts a front end view of a mobile pressure tank in an operational position.

FIG. 3 depicts a rear end view of a mobile pressure tank in an operational position.

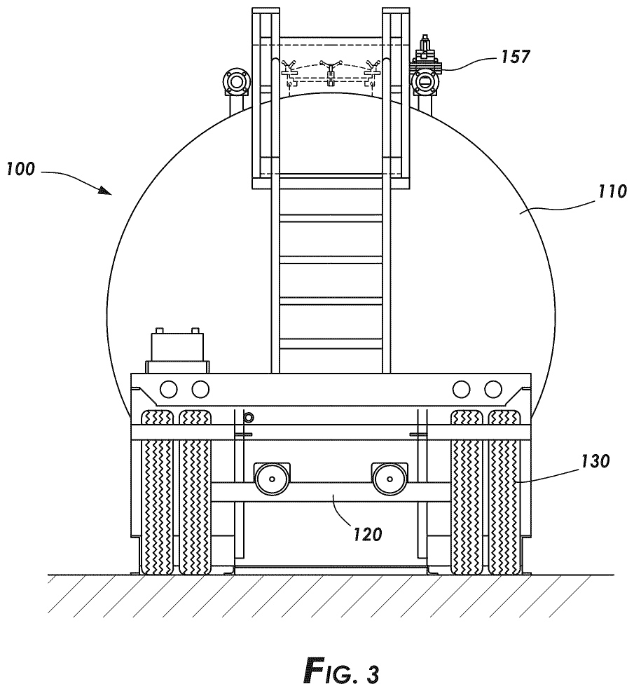

FIG. 4 depicts a top portion of a mobile pressure tank consistent with at least one embodiment of the present disclosure.

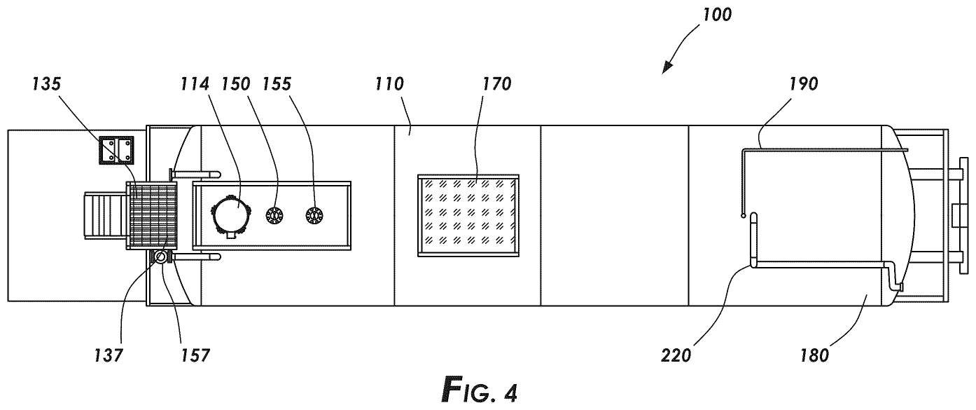

FIG. 5 is a schematic of a pressure tank in fluidic connection with a nitrogen blanket system.

FIG. 6 is a schematic of a pressure tank in fluidic connection with a treatment system.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

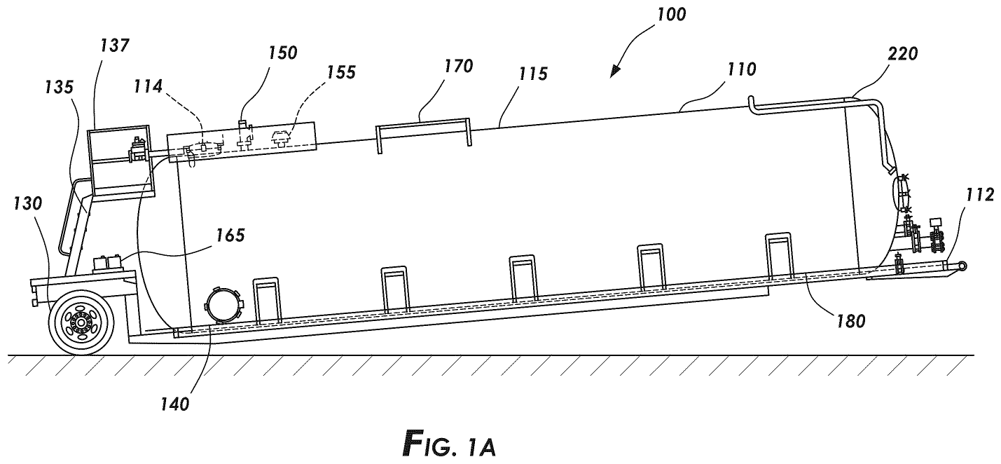

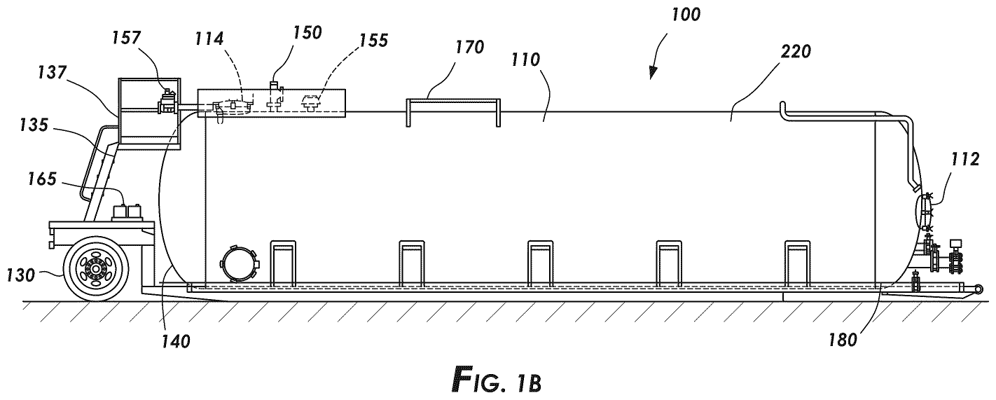

FIG. 1A depicts mobile pressure tank 100 in a transportation position consistent with at least one embodiment of the present disclosure. Mobile pressure tank 100 does not include vapor treatment equipment. Mobile pressure tank 100 includes pressure tank 110 positioned on trailer 140. Trailer 140 may include an axle 120 with tires and wheels 130. In certain embodiments, trailer 140 has a single axle. In those embodiments, mobile pressure tank 100 includes only a single axle.

Mobile pressure tank 100 is in a transportation position when wheels 130 are in contact with the ground and front portion 112 of pressure tank 110 is elevated. In this manner, mobile pressure tank 100 may be towed into position. FIG. 1B depicts mobile pressure tank 100 in an operations position where front portion 112 is in contact with the ground.

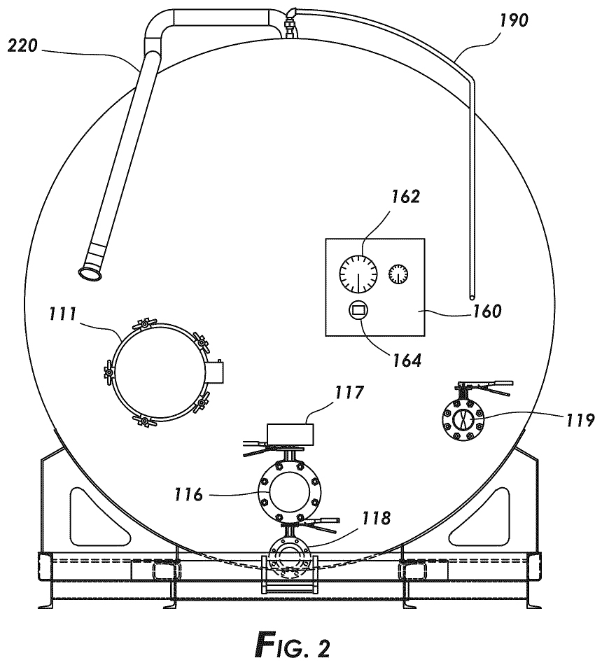

FIGS. 1A and 1B also depict cleaning manway 114 as part of pressure tank 110. Cleaning manway 114 is closed during operation of mobile pressure tank 100. FIG. 2 depicts a front manway 111, which is also closed during operation of mobile pressure tank 100. Top fill line 220 may be used to fill pressure tank 110 from top portion 115.

In some embodiments, mobile pressure tank 100 may include integrated spill containment system 180. Integrated spill containment system 180 may be affixed to trailer 140 or to pressure tank 110. Integrated spill containment system 180 may be adapted to contain spills from pressure tank 110, such as during draining or filling. In certain embodiments, integrated spill containment system 180 may be adapted to hold the entire volume of pressure tank 110.

In certain embodiments, pressure tank 110 may include maximum pressure safety valve 150 for relieving pressure above the maximum pressure setting on pressure tank 110. Maximum pressure safety valve 150 may only operate when the pressure of pressure tank 110 is near or at maximum pressure and may not function during normal operation, as described hereinbelow. Pressure tank 110 may also include vacuum breaker 155. Further, in certain embodiments as described below, pressure tank 110 may include back pressure valve 157. In other embodiments, pressure tank 110 does not include back pressure valve 157.

Mobile pressure tank 100 may also include ladder 135 connecting trailer 140 and top portion 115 of pressure tank 110. In certain embodiments, ladder 135 may include man cage 137 positioned to allow operator access to cleaning manway 114, maximum pressure safety valve 150, back pressure valve 157 (when present), and vacuum breaker 155.

As shown in FIG. 2, pressure tank 110 may include primary fill valve 116, process valve 119, and a bottom liquid drain valve 118.

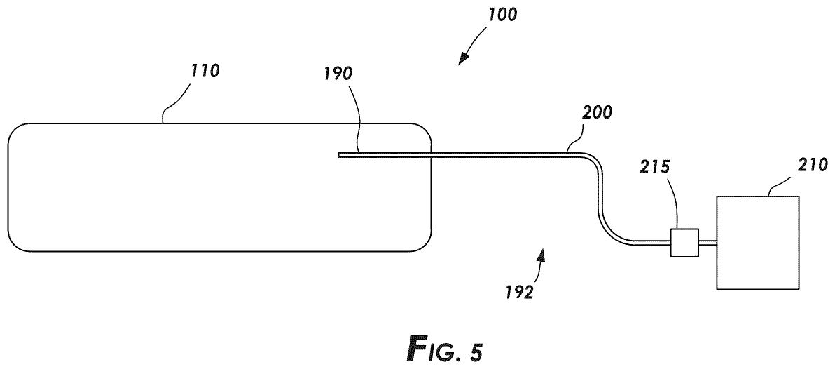

In certain embodiments, mobile pressure tank 100 may include nitrogen blanket system 192. Nitrogen blanket system 192 may include nitrogen fill tube 190 in fluid connection with pressure tank 110. As shown in FIG. 5, nitrogen fill tube 190 may also be fluidly connected to nitrogen source 210 through nitrogen line 200. Nitrogen pressure regulator 215 may be positioned at nitrogen source 210, nitrogen fill tube 190, or elsewhere, and is fluidly connected to pressure tank 110. Nitrogen blanket system 192 thus may include nitrogen fill tube 190, nitrogen source 210, nitrogen line 200 and nitrogen pressure regulator 215. Nitrogen blanket system 192 may be used to form a nitrogen blanket above the fluid contained in pressure tank 110. Nitrogen blanket system pressure may be kept above the vapor pressure of the fluid, below the vapor pressure of the fluid, or at the vapor pressure of the fluid, as described hereinbelow.

Further, in some embodiments, mobile pressure tank 100 may include electronic controls 160, as shown in FIG. 2. Electronic controls 160 may include liquid level gauge 162. In certain embodiments, liquid level gauge 162 may be a radar liquid level gauge. Electronic controls 160 may also include pressure sensor and pressure sensor control 164. Pressure sensor and pressure sensor control 164 may control the rate and total fill level of pressure tank 110 to avoid over pressuring pressure tank 110, such as through motorized valve actuator 117. Although shown in operational connection with primary fill valve 116, motorized valve actuator 117 may also be in operational connection with process valve 119. In some embodiments, one or more solar panels 170 are positioned on pressure tank 110 and in electrical connection with electronic controls 160 for battery 165 charging. In other embodiments, motorized valve actuator 117 may be omitted and primary fill valve, process valve 119, or both may be manually operated.

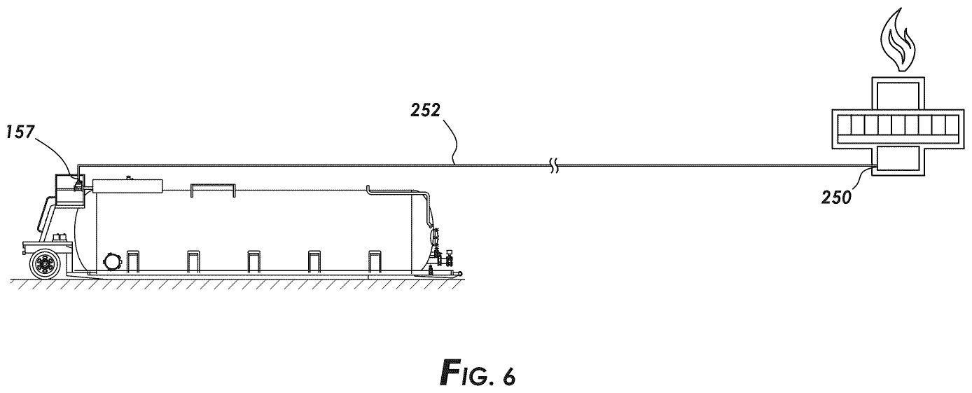

In another embodiment, as depicted in FIG. 6, pressure tank 110 may include back pressure valve 157. Back pressure valve 157 may be connected to treatment system 250 through vent line 252. Treatment system may be, for example, a flare or scrubber, or any suitable method for disposal of vapors from mobile pressure tank 100.

Mobile pressure tank 100 may be operated in different ways. In a first method, pressure tank 110 is adapted to fill without venting. In the first method, pressure tank 110 is operated at a maximum pressure lower than the set pressure of maximum pressure safety valve 150. For example, maximum pressure safety valve set pressure may be set at 75 psig. As pressure tank 110 is filled, pressure tank 110 starts at 0 psi gauge (14.7 psi absolute) pressure. When pressure tank 110 is filled to 80% capacity, the internal pressure may be 64 psi gauge, depending on the fluid being stored. No vapor will have been released or treated as the internal pressure of pressure tank 110 is less than the set pressure of maximum pressure safety valve 150. At this time the fluid will be stored at pressure for as long as needed, again without any vapor treatment. Fluid may be emptied from pressure tank 110 and the tank pressure returns to ambient. Back pressure valve 157 may be omitted from pressure tank 110 when using this method.

In a second method, the internal pressure of pressure tank 110 may depend on the vapor pressure of the stored fluid. The pressure of the nitrogen blanket, as supplied by nitrogen blanket system 192 may be controlled to above the vapor pressure of the fluid. In the second method, as pressure tank 110 is filled, nitrogen is vented through back pressure valve 157 rather than vapors from the fluid. Thus, no vapor treatment is needed.

In a third method, vapors from the stored fluid in excess of a fixed back pressure may be vented through back pressure valve 157 along vent line 252 to treatment system 250. In this third method, nitrogen blanket system 192 may be omitted. As pressure tank 110 is filled, vapors from the fluid are sent to treatment system 250.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A method of operating a mobile pressure tank comprising:
supplying a mobile pressure tank, the mobile pressure tank comprising:
a pressure tank, the pressure tank having a top portion;
a trailer, the pressure tank affixed to the trailer;
a maximum pressure safety valve positioned on the top portion, the maximum pressure safety valve having a maximum pressure; and
a nitrogen blanket system, the nitrogen blanket system having a nitrogen pressure set point;
determining a fluid to be pumped into pressure vessel, the fluid having a fluid vapor pressure;
setting the nitrogen pressure set point above the fluid vapor pressure;
pumping the fluid into the pressure tank; and
relieving pressure in the pressure tank by allowing nitrogen to vent through the back pressure valve.

2. The method of claim 1, wherein the trailer further comprises an axle with wheels.

3. The method of claim 2, wherein the trailer includes only a single axle.

4. The method of claim 1, wherein the pressure tank further comprises a cleaning manway.

5. The method of claim 1 further comprising prior to pumping fluid into the pressure tank:
moving the pressure tank from a transportation position to an operations position.

6. The method of claim 1 wherein the nitrogen blanket system includes:
a nitrogen fill tube in fluid connection with the pressure tank;
a nitrogen line that fluidly connects a nitrogen source and the nitrogen fill tube; and
a nitrogen pressure regulator, the nitrogen pressure regulator fluidly connected to the nitrogen source and adapted to set the nitrogen pressure of the nitrogen blanket system.

7. The method of claim 1, where only nitrogen is vented through the back pressure valve.

8. The method of claim 1, wherein no fluid vapor is treated.

9. The method of claim 1, wherein the mobile pressure tank further comprises a primary fill valve, a process valve, or a bottom liquid drain valve.

10. The method of claim 1, wherein the mobile pressure tank further comprises an integrated spill containment system, the integrated spill containment system affixed to either the trailer or the pressure vessel.

11. A method of operating a mobile pressure tank comprising:
supplying a mobile pressure tank, the mobile pressure tank comprising:
a pressure tank, the pressure tank having a top portion;
a trailer, the pressure tank affixed to the trailer;
a maximum pressure safety valve positioned on the top portion, the maximum pressure safety valve having a maximum pressure;
a primary fill valve, or a process valve; and
electronic controls or manual controls;
pumping the fluid into the pressure tank through the primary fill valve or the process valve; and
controlling the primary fill valve or the process valve to keep a pressure tank pressure below the maximum pressure.

12. The method of claim 11, wherein the electronic controls are in electrical connection with one or more solar panels, the solar panels positioned on the top portion of pressure tank.

13. The method of claim 12, wherein the one or more solar panels are in electrical connection with a battery, the battery positioned on the trailer.

14. The method of claim 11, wherein the pressure tank further comprises a cleaning manway on the top portion of the pressure tank.

15. The method of claim 11 further comprising a top fill line if fluid connection with the pressure tank.

16. The method of claim 11 further comprising prior to pumping the fluid into the pressure tank:
transporting the pressure tank using the trailer in a transportation position; and
moving the pressure tank from the transportation position to the operations position.

17. The method of claim 11, wherein the trailer has a single axle.

18. The method of claim 11, wherein the pressure tank has a vacuum breaker.

19. The method of claim 11, wherein the mobile pressure tank has no pressure treating equipment.

20. The method of claim 12 further comprising after controlling the primary fill valve or the process valve:
emptying the pressure tank.

21. The method of claim 11, wherein the mobile pressure tank further comprises an integrated spill containment system, the integrated spill containment system affixed to either the trailer or the pressure vessel.

22. The method of claim 11, wherein the primary fill valve or the process valve has a motorized valve actuator.

23. The method of claim 22, wherein the electronic controls comprise a pressure actuator and pressure sensor control, the pressure actuator and pressure sensor control in electrical connection with the motorized actuator.

24. The method of claim 23, wherein the step of controlling the primary fill valve or the process valve to keep a pressure tank pressure below the maximum pressure is performed by the pressure actuator and pressure sensor control.

25. The method of claim 23, wherein the electronic controls further comprise a liquid level gauge in electrical connection with the pressure tank or the motorized valve actuator.

26. The method of claim 25, wherein the step of controlling the primary fill valve or the process valve to keep a pressure tank pressure below the maximum pressure is performed by the liquid level gauge in combination with the pressure actuator and pressure sensor control.

27. A method of operating a mobile pressure tank comprising:
supplying a mobile pressure tank, the mobile pressure tank comprising:
a pressure tank, the pressure tank having a top portion and a back pressure valve on the top portion;
a trailer, the pressure tank affixed to the trailer;
a maximum pressure safety valve positioned on the top portion, the maximum pressure safety valve having a maximum pressure; and
determining a fluid to be pumped into pressure vessel, the fluid having a fluid vapor pressure;
setting a fixed back pressure;
pumping the fluid into the pressure tank; and
relieving pressure in the pressure tank by allowing vapors in the tank to exit through the back pressure valve to a treatment system.

28. The method of claim 27, wherein the trailer further comprises an axle with wheels.

29. The method of claim 28, wherein the trailer includes only a single axle.

30. The method of claim 27, wherein the pressure tank further comprises a cleaning manway.

31. The method of claim 27 further comprising prior to pumping fluid into the pressure tank:
moving the pressure tank from a transportation position to an operations position.

32. The method of claim 27, wherein the mobile pressure tank further comprises a primary fill valve, a process valve, or a bottom liquid drain valve.

33. The method of claim 27, wherein the mobile pressure tank further comprises an integrated spill containment system, the integrated spill containment system affixed to either the trailer or the pressure vessel.

34. The method of claim 27, wherein the treatment system is a flare or scrubber.
